(19) United States
(12) Patent Application Publication
(10) Pub. No.: US 2017/0282340 A1
(43) Pub. Date: Oct. 5, 2017

(54) HAND TOOL

(71) Applicant: MAX CO., LTD., Tokyo (JP)

(72) Inventors: Hiroshi TANAKA, Tokyo (JP); Tohru UCHIYAMA, Tokyo (JP); Mitsugu TAKEZAKI, Tokyo (JP); Hiroki YAMAMOTO, Tokyo (JP)

(73) Assignee: MAX CO., LTD., Tokyo (JP)

(21) Appl. No.: 15/461,804

(22) Filed: Mar. 17, 2017

(30) Foreign Application Priority Data
Mar. 29, 2016 (JP) 2016-065609

(51) Int. Cl. B25C 1/04; B25C 1/00

(52) U.S. Cl. CPC B25C 1/047; B25C 1/001; B25C 1/008

(57) ABSTRACT

A hand tool includes a trigger manually operated by an operator, a tool body configured to movably support the trigger, a biasing member configured to generate a biasing force for biasing the trigger in a direction opposite to a operation direction of the trigger, and a contacting member operated by a biasing force of the biasing member to act on the trigger or tool body. The biasing member and the contacting member are assembled integrally with the tool body or the trigger.

### CROSS-REFERENCE TO RELATED APPLICATION

This application claims priority from Japanese Patent Application No. 2016-065609 filed on Mar. 29, 2016 the entire contents of which are incorporated herein by reference.

### FIELD

The present disclosure relates to a hand tool provided with a trigger.

### BACKGROUND

A hand tool such as a nail driving machine operated by an operation of a trigger includes a biasing means which cause the trigger to return to an initial position so as to prevent that the trigger is unintentionally operated by its own weight.

For example, in Japanese Unexamined Patent Application Publication No. 10-146775 (JP H10-146775 A), there is disclosed a tool in which a spring for causing a trigger to return to an initial position is built. An unintentional operation of the tool is prevented when the spring biases the trigger to the initial position, and thus safety can be improved.

However, the hand tool described in JP H10-146775 A, when the trigger is detached from a tool body for maintenance and the like, the spring comes off together, which may cause loss or damage of the spring. In addition, when the detached trigger is attached, the trigger is assembled necessarily in a state where the spring is deformed, so that assemblability is deteriorated, which is problematic.

In this regard, an object of the disclosure is to provide a hand tool which can prevent loss or damage of a spring at the time of maintenance of a trigger, and can improve an assemblability of the trigger.

The disclosure is made to solve the above-described problem, and is characterized as follows.

A first aspect of the disclosure is to provide a hand tool which includes a trigger manually operated by an operator, the hand tool including:

a tool body configured to movably support the trigger; a biasing member configured to generate a biasing force for biasing the trigger in a direction opposite to a operation direction of the trigger; and a contacting member operated by a biasing force of the biasing member to act on the trigger, wherein the biasing member and the contacting member are assembled integrally with the tool body.

The trigger may be detachable with respect to a support member configured to movably support the trigger, and the biasing member and the contacting member may be assembled with the support member.

The hand tool may further include a support member which is assembled with the trigger, the biasing member, and the contacting member, wherein the support member is detachable with respect to the tool body.

The tool body may include a movement regulating part configured to regulate a movement of the contacting member by the biasing member in a biasing direction, a space may be formed on a tip side of the contacting member as the movement regulating part regulates the movement of the contacting member, and the trigger may include a pressed part which is inserted into the space to be pressed by the contacting member.

The tool body may include an opening through which the trigger is capable of being inserted and extracted, and the space may be disposed to face outside through the opening in a state where the trigger is detached.

A second aspect of the disclosure is to provide a hand tool which includes a trigger manually operated by an operator, the hand tool including: a tool body configured to movably support the trigger; a biasing member configured to generate a biasing force for biasing the trigger in a direction opposite to a operation direction of the trigger; and a contacting member operated by a biasing force of the biasing member to act on the tool body, wherein the biasing member and the contacting member are assembled integrally with the trigger.

The hand tool may further include a support member with which the trigger is assembled, wherein the contacting member is provided in the trigger to be operated by a biasing force of the biasing member to act on the support member, and the support member is detachable with respect to the tool body.

The tool body may include a space which is formed at a tip side of a pressed part pressed by the contacting member, the trigger may include a movement regulating part configured to regulate a movement of the contacting member by the biasing member in a biasing direction, and the contacting member may be capable of being inserted into the space as the movement of the contacting member is regulated by the movement regulating part.

The tool body may include an opening through which the trigger is capable of being inserted and extracted, and the space may be disposed to face outside through the opening in a state where the trigger is detached.

As described above, since the biasing member and the contacting member are assembled integrally with the tool body, when the trigger, for the maintenance and the like, is detached from the tool body, the biasing member such as a spring is not fallen. Accordingly, it is possible to prevent loss or damage of the biasing member. In addition, the detached trigger is easily assembled. In addition, the use of the damaged biasing member or an assembly error of the biasing member can be prevented, thereby improving safety.

As described above, the trigger is detachable with respect to the support member which movably supports the trigger, and the biasing member and the contacting member are assembled with the support member. With such a configuration, the support member obtained by unifying the biasing member and the contacting member is easily attached in the tool body, which improves assemblability.

As described above includes a support member which is assembled with the trigger, the biasing member, and the contacting member, and the support member is detachable with respect to the tool body. With such a configuration, the support member obtained by unifying the trigger, the biasing member, and the contacting member as a unit can be attached in and detached from the tool body, which improves the assemblability.

As described above, when the movement regulating part regulates the movement of the contacting member, the space is formed on the tip side of the contacting member, and the trigger includes a pressed part which is inserted into the space to be pressed by the contacting member. With such a configuration, merely by inserting the pressed part into the space, the trigger can be assembled while the load of the biasing member is rarely received. Accordingly, it is possible to improve the assemblability of the trigger.

As described above, the tool body includes the opening through which the trigger can be inserted and extracted, and in a state where the trigger is detached, the space is disposed to face outside through the opening. With such a configuration, when the trigger is attached toward the space, the trigger can be assembled by being inserted linearly from the opening. Accordingly, the assemblability of the trigger is improved.

As described above, since the biasing member and the contacting member are assembled integrally with the trigger, when the trigger for the maintenance and the like is detached from the tool body, the biasing member such as a spring is not fallen. Accordingly, it is possible to prevent loss or damage of the biasing member. In addition, the detached trigger is easily assembled. In addition, the use of the damaged biasing member or an assembly error of the biasing member can be prevented, thereby improving safety.

As described above includes the support member with which the trigger is assembled. The contacting member is provided in the trigger to be operated by the biasing force of the biasing member to act on the support member, and the support member is detachable with respect to the tool body. With such a configuration, the support member with which the trigger is assembled can be attached in or detached from the tool body, which improves the assemblability.

As described above, in the tool body, the space is formed on the tip side of the pressed part pressed by the contacting member. When the movement of the contacting member is regulated by the movement regulating part, the contacting member can be inserted into the space. With such a configuration, when the contacting member is inserted into the space, the trigger can be assembled while the load of the biasing member is rarely received. Accordingly, it is possible to improve the assemblability of the trigger.

As described above, the tool body includes the opening through which the trigger can be inserted and extracted. In a state where the trigger is detached, the space is disposed to face outside through the opening. With such a configuration, when the trigger is attached toward the space, the trigger can be assembled by being inserted linearly from the opening. Accordingly, the assemblability of the trigger is improved.

### BRIEF DESCRIPTION OF DRAWINGS

FIG. 1 is a cross-sectional side view illustrating a hand tool;

FIG. 2 is a partially enlarged sectional view illustrating a vicinity of a trigger in an initial state;

FIG. 3 is a partially enlarged sectional view illustrating the vicinity of the trigger in a state where the trigger is pulled;

FIG. 4 is a partially enlarged sectional view illustrating the vicinity of the trigger in a state where the trigger is detached;

FIGS. 5A and 5B are perspective views illustrating an appearance of a trigger structure seen from the oblique rear side, wherein FIG. 5A is a view in the state of being assembled, and

FIG. 5B is a view in the state where the trigger is detached;

FIG. 6 is a perspective view illustrating the appearance of the trigger structure viewed from the oblique rear side in a state where a biasing member and a contacting member are disassembled;

FIG. 7 is a perspective view illustrating the appearance of the trigger structure viewed from an oblique front side in the state where the biasing member and the contacting member are disassembled;

FIG. 8 is a partially enlarged sectional view illustrating a vicinity of a trigger according to a second embodiment in an initial state;

FIG. 9 is a partially enlarged sectional view illustrating the vicinity of the trigger according to the second embodiment in a state where the trigger is pulled; and

FIG. 10 is a partially enlarged sectional view illustrating the vicinity of the trigger according to the second embodiment in a state where the trigger is detached.

### DETAILED DESCRIPTION

### First embodiment

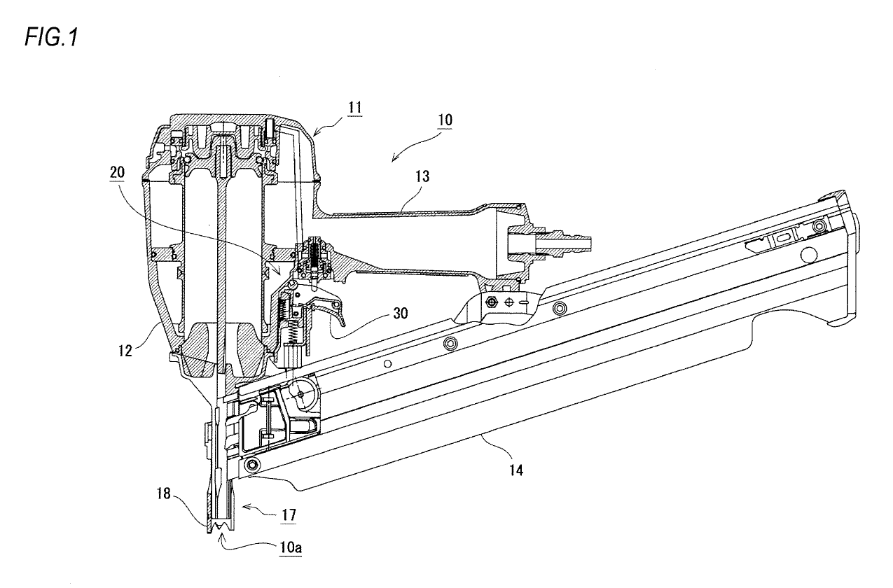

A first embodiment of the disclosure will be described with reference to FIGS. 1 to 7.

A hand tool 10 according to this embodiment is a driving tool, and is configured such that a fastener such as a screw or a nail is launched from an injection port 10a, and the fastener is driven to a driving target material. The hand tool 10 drives the fastener with a driver which is vertically driven by a predetermined power source. In this embodiment, a driving operation is performed by using compressed air supplied from outside. In addition, the power source of the hand tool 10 is not limited to the compressed air, and the hand tool 10 may be operated by using electricity, spring force, or the like, or may be operated by using combustion pressure of combustible gases. The hand tool 10 is not limited to the driving tool, and may be a tool including a trigger such as a circular saw, a drill driver, and a disc grinder.

As illustrated in FIG. 1, a tool body 11 of the hand tool 10 includes an output part 12 in which an operating mechanism and the like for performing the driving operation is built, a grip part 13 which is connected with the output part 12 at substantially right angle, a nose part 17 which is fixed integrally with the tip side of the output part 12 in an axial direction (a driving direction of the fastener), and a magazine 14 which is connected with the rear side of the nose part 17. In addition, a trigger attaching part 20 for attaching a trigger 30 is provided in a boundary portion between the output part 12 and the grip part 13.

The trigger 30 is manually operated by an operator to operate the hand tool 10, and is an operation part for executing the driving operation in this embodiment. The trigger 30 is provided in a position where the operation can be performed with a forefinger when the grip part 13 is griped. When the trigger 30 is pulled in a state where a contact member 18 (to be described later) is pushed to the driving target material, the operating mechanism built in the output part 12 is operated to execute the driving operation.

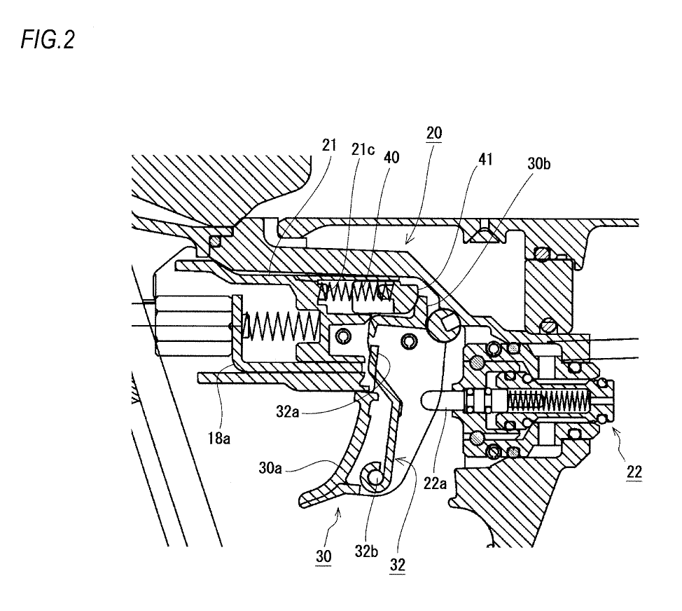

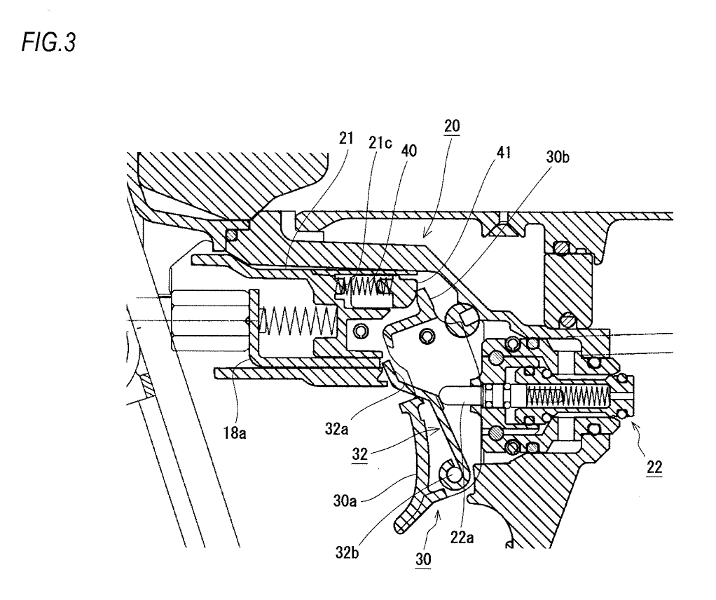

As illustrated in FIGS. 2 and 3, the trigger 30 includes an operation part 30a on one end side and a pressed part 30b on the other end side. The operation part 30a is a part which is exposed from the tool body 11 to be operable, and is operated by the operator with a finger. In addition, the pressed part 30b is a part which is inserted into the tool body 11, and is swung in an opposite direction to the operation part 30a when the operation part 30a is operated to swing the trigger 30. The pressed part 30b is biased to the rear side by the contacting member 41 (to be described later), and thus the trigger 30 is usually biased in a direction of an initial position.

A contact lever 32 for operating a valve stem 22a of a trigger valve 22 is swingably attached in the trigger 30. The contact lever 32 is swingably supported by a spindle 32b formed in the operation part 30a. A tip 32a of the contact lever 32 which is not supported by the spindle 32b is disposed to face a contact interlocking member 18a (to be described later).

The magazine 14 is a part containing the fastener to be injected from the injection port 10a, and contains the connected fastener. The fastener contained in the magazine 14 is guided in order in a direction of the nose part 17 to be used for driving.

The nose part 17 is a part forming the injection port 10a through which the fastener is injected, and is formed to protrude to the tip of the tool body 11. The driver for driving out the fastener is slidably contained in the nose part 17. A fastener supply mechanism is provided on the rear side of the nose part 17. The fastener supply mechanism executes a feeding operation in conjunction with a driving operation. According to the feeding operation, the fastener contained in the magazine 14 is fed to the nose part 17 in order.

In the nose part 17, the contact member 18 is attached slidably. The contact member 18 is biased to protrude from the tip of the nose part 17, and can be pushed by a driving target material. When pushed to the driving target material, the contact member 18 slides to a direction opposite to the tip of the nose part 17. When the contact member 18 slides in the direction opposite to the tip of the nose part 17 as above, a safety mechanism of the driving operation is operated. When the safety mechanism is operated, the operation of the trigger 30 becomes effective, so that the fastener can be driven.

Specifically, when the contact member 18 is slid in the direction opposite to the tip of the nose part 17, the contact interlocking member 18a illustrated in FIGS. 2 to 4 moves to the rear side (right direction in FIGS. 2 to 4) in conjunction with the movement of the contact member 18. When the contact interlocking member 18a moves to the rear side, the tip 32a of the contact lever 32 is pushed in a direction of the trigger valve 22. When the trigger 30 is pulled in such a state, the valve stem 22a of the trigger valve 22 is pressed inside by the intermediate portion of the contact lever 32. When the valve stem 22a is pressed inside, the compressed air flows in a piston of the output part 12 at once to perform the driving operation.

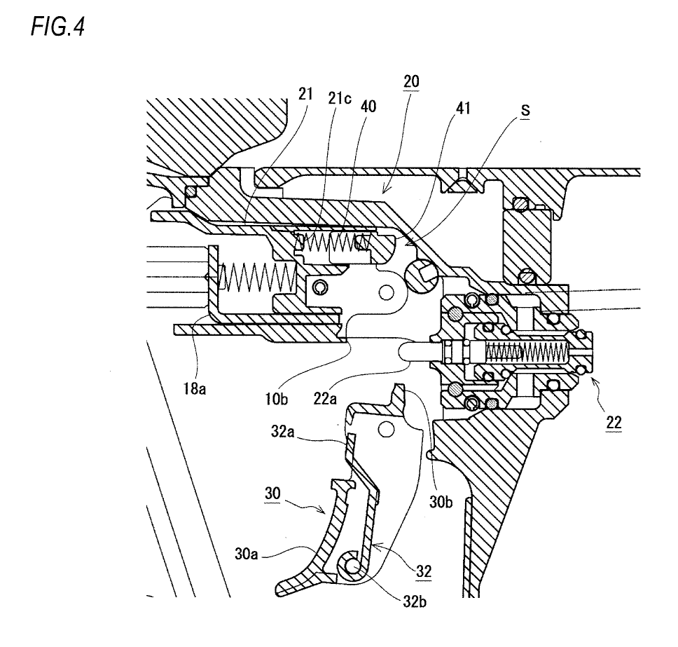

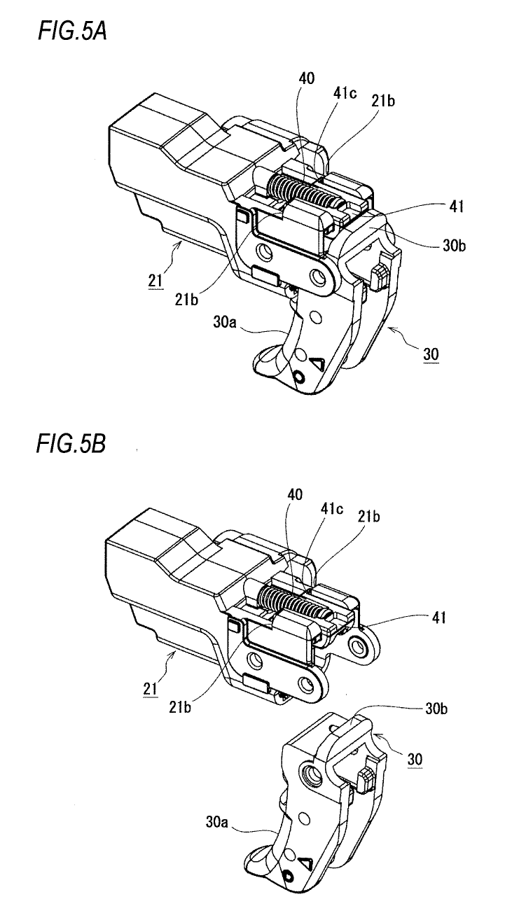

As illustrated in FIGS. 2 and 3, the above-described trigger 30 is supported to be swingable in the tool body 11. Specifically, as illustrated in FIG. 5A, a support member 21 is attached in the trigger attaching part 20 of the tool body 11, and the trigger 30 is swingably attached in the support member 21. The trigger 30 is attached by a fixing means (not illustrated) such as a pin or a bolt inserted from the side surface of the tool body 11. For this reason, as illustrated in FIGS. 4 and 5B, the trigger 30 can be detached from the tool body 11 by detaching the fixing means. In addition, in this embodiment, the support member 21 in which the trigger 30 is detachable is built in the tool body 11. However, the entire support member 21 is not necessarily covered with the tool body 11. The trigger 30 may be detachable with respect to the support member 21 in a state where the support member 21 is attached in the tool body 11.

As illustrated in FIG. 5B, the biasing member 40 and the contacting member 41 are assembled integrally with the support member 21. In other words, the biasing member 40 and the contacting member 41 are assembled integrally with the tool body 11 with which the support member 21 is assembled. For this reason, as illustrated in FIG. 4, even when the trigger 30 is detached from the tool body 11, the biasing member 40 and the contacting member 41 remain on the tool body 11.

The biasing member 40 generates a biasing force for biasing the trigger 30 in an opposite operation direction. The biasing member 40 according to this embodiment is a compressed spring which biases the contacting member 41 (to be described later). In addition, the biasing member 40 is not limited to the compressed spring, and may be any one which generates a predetermined biasing force. The biasing member may be, for example, a tension spring, another elastic body, a biasing member operated by air, or solenoid operated by electricity.

The contacting member 41 is operated by the biasing force of the biasing member 40 to act on the trigger 30, and is disposed between the biasing member 40 and the trigger 30. The contacting member 41 includes a spring attaching part 41a in which the biasing member 40 is attached, a sliding protrusion 41b formed to protrude to both sides, and an engagement part 41c which is engaged with a movement regulating part 21b (to be described later). The contacting member 41 is slidably attached in the support member 21 by engaging the sliding protrusion 41b in a sliding groove 21a (to be described later). In addition, the spring attaching part 41a is biased in a direction of being engaged in the trigger 30 by receiving the biasing force of the biasing member 40. The contacting member 41 biased by the biasing member 40 is slid to a position where the engagement part 41c abuts on the movement regulating part 21b. After the trigger 30 is pulled, the contacting member 41 presses the pressed part 30b of the trigger 30, so that the pulled trigger 30 returns to the initial position.

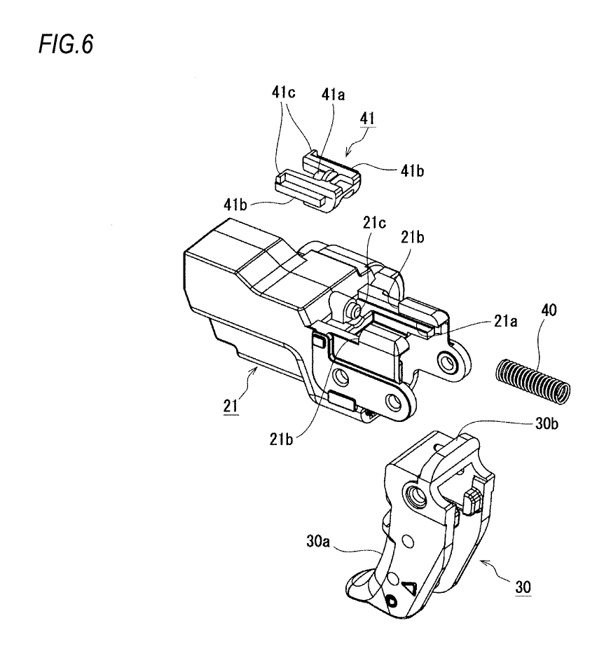

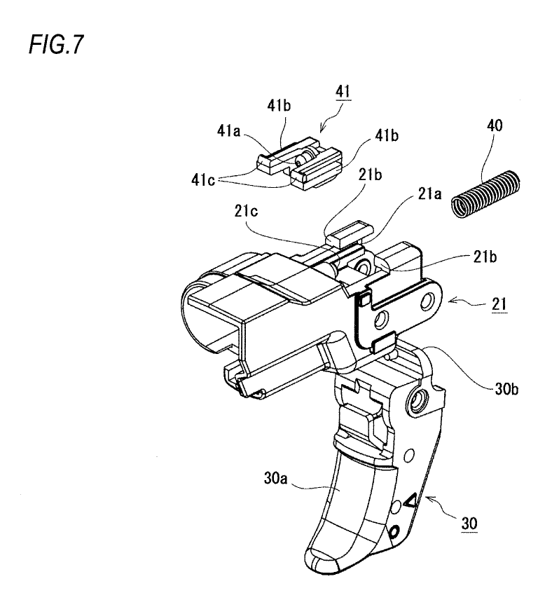

As illustrated in FIGS. 6 and 7, the support member 21 with which the biasing member 40 and the contacting member 41 are assembled includes the sliding groove 21a which guides the movement of the contacting member 41, the movement regulating part 21b which regulates the movement of the contacting member 41, and a spring receiving part 21c which receives the biasing force of the biasing member 40.

The sliding groove 21a is a groove into which the sliding protrusion 41b of the contacting member 41 is inserted, and guides the sliding of the contacting member 41. When the sliding protrusion 41b of the contacting member 41 is engaged with the sliding groove 21a, the contacting member 41 can be slid in a front and rear direction along a longitudinal direction of the sliding groove 21a.

The movement regulating part 21b is a wall portion which is engaged with the engagement part 41c of the contacting member 41. When the engagement part 41c of the contacting member 41 is engaged with the movement regulating part 21b, it is prevented that the contacting member 41 is fallen from the sliding groove 21a, and it is regulated that the contacting member 41 moves in the biasing direction of the biasing member 40. As illustrated in FIG. 4, when the movement of the contacting member 41 in a protruding direction is regulated as above, a space S is formed on the tip side of the contacting member 41 in the tool body 11. The space S is used to insert the pressed part 30b of the trigger 30. The width of the space S is formed to be the same as the width of the pressed part 30b of the trigger 30, or to be slightly larger than the width of the pressed part 30b of the trigger 30. For this reason, when the pressed part 30b of the trigger 30 is inserted into the space S, the biasing force of the biasing member 40 does not act on the pressed part 30b. In addition, the width of the space S may be formed to be slightly smaller than the width of the pressed part 30b of the trigger 30. With such a configuration, play of the trigger 30 may be prevented to improve the response of the trigger 30.

The spring receiving part 21c is a part for attaching the biasing member 40. The spring receiving part 21c is disposed to face the spring attaching part 41a of the contacting member 41. When the compressed biasing member 40 is attached between the spring receiving part 21c and the spring attaching part 41a of the contacting member 41, the support member 21 and the contacting member 41 are biased in a direction of being separated to each other.

As illustrated in FIG. 4, when the trigger 30 is detached from the support member 21 (that is, when the trigger 30 is detached from the tool body 11), an opening 10b through which the trigger 30 can be inserted and extracted is provided in the tool body 11. When the opening 10b is opened, the biasing member 40 receives the biasing force, and the movement of the contacting member 41 in a protruding direction is regulated. The tip of the contacting member 41 does not contact the inner wall of the tool body 11, and the space S is formed between the tip of the contacting member 41 and the inner wall of the tool body 11. The space S is disposed to face outside through the opening 10b. For this reason, if the trigger 30 is inserted linearly from the opening 10b at the time of attaching the detached trigger 30 again, the pressed part 30b is formed to protrude to the upper end of the trigger 30 inserted into the space S.

As described above, in this embodiment, since the biasing member 40 and the contacting member 41 are integrally assembled with the tool body 11, when the trigger 30 is detached from the tool body 11 for the maintenance and the like, the biasing member 40 such as a spring is not fallen. Accordingly, it is possible to prevent loss or damage of the biasing member 40. Also, the detached trigger 30 is easily assembled.

When the movement regulating part 21b regulates the movement of the contacting member 41, the space S is formed on the tip side of the contacting member 41. The trigger 30 includes the pressed part 30b inserted into the space S. With such a configuration, merely by inserting the pressed part 30b in the space S, the trigger 30 can be assembled while the load of the biasing member 40 is rarely received. Accordingly, it is possible to improve the assemblability of the trigger 30. In addition, the use of the damaged biasing member 40 or an assembly error of the biasing member 40 can be prevented to improve safety.

The tool body 11 includes the opening 10b through which the trigger 30 can be inserted and extracted, and the space S is disposed to face outside through the opening 10b in the state where the trigger 30 is detached. With such a configuration, when the trigger 30 is attached toward the space S, the trigger 30 can be assembled by being inserted linearly from the opening 10b. Accordingly, the assemblability of the trigger 30 is improved.

### Second Embodiment

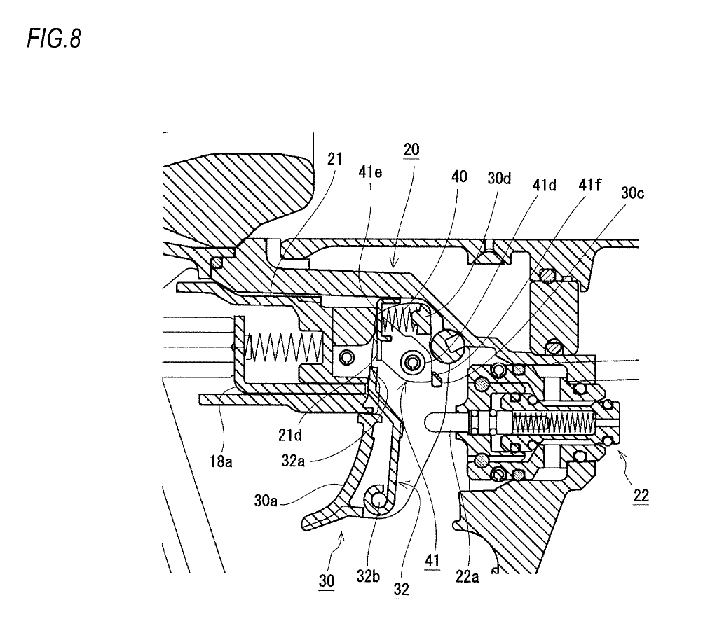

The second embodiment of the disclosure will be described with reference to FIGS. 8 to 10. This embodiment is characterized by that the biasing member 40 and the contacting member 41 are assembled integrally with the trigger 30 rather than that the biasing member 40 and the contacting member 41 are assembled integrally with the tool body 11. In addition, the basic configuration of this embodiment is not different from that of the first embodiment, and thus in order to avoid redundant description, only different parts will be described.

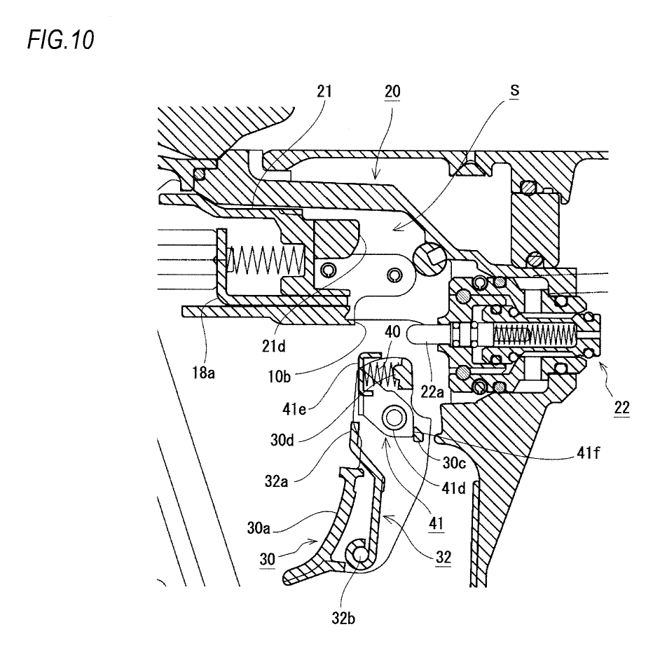

As illustrated in FIGS. 8 to 10, with the trigger 30 according to this embodiment, the biasing member 40 and the contacting member 41 are assembled integrally. For this reason, as illustrated in Fig.10, when the trigger 30 is detached from the tool body 11, the biasing member 40 and the contacting member 41 are detached integrally with the trigger 30.

The biasing member 40 generates a biasing force for biasing the trigger 30 to the initial position. The biasing member 40 according to this embodiment is a compressed spring which biases the contacting member 41 (to be described later). In addition, the biasing member 40 is not limited to the compressed spring, and may be any one which generates a predetermined biasing force. The biasing member may be, for example, a tension spring, another elastic body, a biasing member operated by air, or solenoid operated by electricity.

The contacting member 41 is operated by the biasing force of the biasing member 40 to press the pressed part 21d of the tool body 11, and is swingably attached inside the trigger 30. The contacting member 41 includes a swing shaft part 41d for attaching swingably with respect to the trigger 30, a pressing part 41e disposed to face the pressed part 21d of the tool body 11, and an engaging part 41f engaging with a movement regulating part 30c (to be described later) of the trigger 30.

As illustrated in FIGS. 8 to 10, the trigger 30 with which the biasing member 40 and the contacting member 41 are assembled includes the movement regulating part 30c which regulates the movement of the contacting member 41, and a spring receiving part 30d which receives the biasing force of the biasing member 40.

The movement regulating part 30c is a protruding part engaged with the engaging part 41f of the contacting member 41. When the engaging part 41f of the contacting member 41 is engaged with the movement regulating part 30c, it is regulated that the contacting member 41 is swung by the biasing member 40 in a biasing direction. As illustrated in FIG. 10, when the swinging of the contacting member 41 is regulated as above, the contacting member 41 is regulated not to swing from the trigger 30 in a protruding direction. Since the contacting member 41 does not protrude from the trigger 30, the contacting member 41 is easily inserted into the space S (to be described later).

The spring receiving part 30d is a part for attaching one end of the biasing member 40. The spring receiving part 30d is disposed to face the back side of the pressing part 41e of the contacting member 41. Since the other end of the biasing member 40 is attached on the back side of the pressing part 41e of the contacting member 41, the spring receiving part 30d and the pressing part 41e are biased by the biasing member 40 in a direction of being separated to each other.

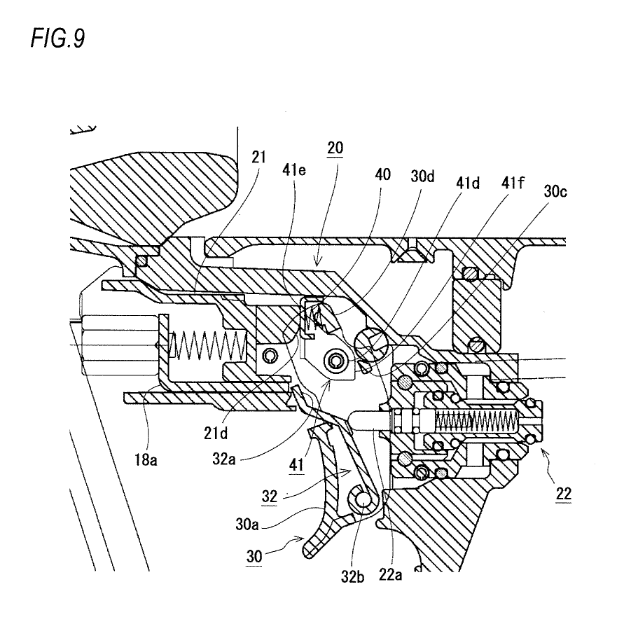

As illustrated in FIG. 9, when the trigger 30 is pulled, the trigger 30 is swung with respect to the contacting member 41 so that the biasing member 40 is compressed. Thereafter, when the trigger 30 is released, by the restoring force of the biasing member 40, the pressing part 41e of the contacting member 41 presses the pressed part 21d of the tool body 11, and by the counterforce thereof, the pulled trigger 30 returns to the initial position.

As illustrated in FIGS. 8 to 10, the support member 21 according to this embodiment is attached in the tool body 11, and includes the pressed part 21d pressed by the contacting member 41. As illustrated in FIG. 10, the space S for inserting the upper end of the trigger 30 and the contacting member 41 is formed on the tip side of the pressed part 21d. In addition, in this embodiment, the support member 21 in which the trigger 30 is detachable is built in the tool body 11. However, the entire support member 21 is not necessarily covered with the tool body 11. In a state where the support member 21 is attached in the tool body 11, the trigger 30 may be detachable with respect to the support member 21.

The width of the space S is formed to be the same as the width of the upper end of the trigger 30 inserted into the space S and the contacting member 41, or to be slightly larger than the width of the upper end of the trigger 30 and the contacting member 41 which are inserted in the space S. For this reason, when the trigger 30 is inserted into the space S, the biasing force of the biasing member 40 does not act thereon. In addition, the width of the space S may be formed to be slightly smaller than the width of the upper end of the trigger 30 and the contacting member 41 which are inserted into the space S. With such a configuration, play of the trigger 30 can be prevented to improve the response of the trigger 30.

When the trigger 30 is detached from the support member 21 (that is, when the trigger 30 is detached from the tool body 11), as illustrated in FIG. 10, the opening 10b through which the trigger 30 can be inserted and extracted is provided in the tool body 11. In addition, the above-described space S is disposed to face outside through the opening 10b. For this reason, if the trigger 30 is inserted linearly from the opening 10b at the time of attaching the detached trigger 30 again, the upper end of the trigger 30 and the contacting member 41 are inserted into the space S.

As described above, in this embodiment, since the biasing member 40 and the contacting member 41 are integrally assembled with the trigger 30, the biasing member 40 such as a spring is not fallen when the trigger 30 is detached from the tool body 11 for the maintenance and the like. Accordingly, it is possible to prevent loss or damage of the biasing member 40. In addition, the detached trigger 30 is easily assembled. In addition, the use of the damaged biasing member 40 or an assembly error of the biasing member 40 can be prevented to improve safety

In the tool body 11, the space S is formed on the tip side of the pressed part 21d pressed by the contacting member 41, and the movement of the contacting member 41 is regulated by the movement regulating part 30c so that the contacting member 41 can be inserted into the space S. With such a configuration, when the contacting member 41 is inserted into the space S, the trigger 30 can be assembled while the load of the biasing member 40 is rarely received. Accordingly, it is possible to improve the assemblability of the trigger 30.

The tool body 11 includes the opening 10b through which the trigger 30 can be inserted and extracted, and the space S is disposed to face outside through the opening 10b in a state where the trigger 30 is detached. With such a configuration, when the trigger 30 is attached toward the space S, the trigger 30 can be assembled by being inserted linearly from the opening 10b. Accordingly, the assemblability of the trigger 30 is improved.

In the above-described second embodiment, the trigger 30 is detachable with respect to the support member 21. However, the support member 21 assembled with the trigger 30 may be detachable with respect to the tool body 11. That is, a unit obtained by assembling the trigger 30, the biasing member 40, and the contacting member 41 with the support member 21 in advance may be detachable with respect to the tool body 11. Also in the case of such a configuration, the biasing member 40 and the contacting member 41 are assembled integrally with the trigger 30, and thus the biasing member 40 and the contacting member 41 can be detached together with the trigger 30, so that the same effect as in the above-described second embodiment can be obtained.

In the above-described first embodiment and second embodiment, the swinging trigger 30 has been described. However, the same effect can be also obtained in the linearly-sliding trigger 30.

1. A hand tool comprising:
a trigger manually operated by an operator;
a tool body configured to movably support the trigger;
a biasing member configured to generate a biasing force for biasing the trigger in a direction opposite to a operation direction of the trigger; and
a contacting member operated by a biasing force of the biasing member to act on the trigger,
wherein the biasing member and the contacting member are assembled integrally with the tool body.

2. The hand tool according to claim 1,
wherein the trigger is detachable with respect to a support member configured to movably support the trigger, and
wherein the biasing member and the contacting member is assembled with the support member.

3. The hand tool according to claim 1 further comprising a support member which is assembled with the trigger, the biasing member, and the contacting member,
wherein the support member is detachable with respect to the tool body.

4. The hand tool according to claim 1,
wherein the tool body comprises a movement regulating part configured to regulate a movement of the contacting member by the biasing member in a biasing direction,
wherein a space is formed on a tip side of the contacting member as the movement regulating part regulates the movement of the contacting member, and
wherein the trigger comprises a pressed part which is inserted into the space to be pressed by the contacting member.

5. The hand tool according to claim 2,
wherein the tool body comprises a movement regulating part configured to regulate a movement of the contacting member by the biasing member in a biasing direction,
wherein a space is formed on a tip side of the contacting member as the movement regulating part regulates the movement of the contacting member, and
wherein the trigger comprises a pressed part which is inserted into the space to be pressed by the contacting member.

6. The hand tool according to claim 4,
wherein the tool body comprises an opening through which the trigger is capable of being inserted and extracted, and
wherein the space is disposed to face outside through the opening in a state where the trigger is detached.

7. The hand tool according to claim 5,
wherein the tool body comprises an opening through which the trigger is capable of being inserted and extracted, and
wherein the space is disposed to face outside through the opening in a state where the trigger is detached.

8. A hand tool comprising:
a trigger manually operated by an operator;
a tool body configured to movably support the trigger;
a biasing member configured to generate a biasing force for biasing the trigger in a direction opposite to a operation direction of the trigger; and
a contacting member operated by a biasing force of the biasing member to act on the tool body,
wherein the biasing member and the contacting member are assembled integrally with the trigger.

9. The hand tool according to claim 8, further comprising a support member with which the trigger is assembled,
wherein the contacting member is provided in the trigger to be operated by a biasing force of the biasing member to act on the support member, and
wherein the support member is detachable with respect to the tool body.

10. The hand tool according to claim 8,
wherein the tool body comprises a space which is formed at a tip side of a pressed part pressed by the contacting member,
wherein the trigger comprises a movement regulating part configured to regulate a movement of the contacting member by the biasing member in a biasing direction, and
wherein the contacting member is capable of being inserted into the space as the movement of the contacting member is regulated by the movement regulating part.

11. The hand tool according to claim 10,
wherein the tool body comprises an opening through which the trigger is capable of being inserted and extracted, and
wherein the space is disposed to face outside through the opening in a state where the trigger is detached.
